(19) United States
(12) Patent Application Publication
(10) Pub. No.: US 2007/0239672 A1
(43) Pub. Date: Oct. 11, 2007

(54) Client Category Configuration

(75) Inventors: Gowri S. Paranthaman, Redmond, WA (US); Karthik Lakshminarayanan, Redmond, WA (US); Trevor Foucher, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/277,884

(22) Filed: Mar. 29, 2006

(51) Int. Cl. G06F 17/30

(52) U.S. Cl. 707/3

(57) ABSTRACT

Client category configuration is described, in which, a computer-implemented method may be employed to find categories of clients based on configuration data obtained from the clients. A configuration recommendation is then created for a particular one of the categories based on configuration of one or more of the clients included in the particular category.

### BACKGROUND

The functionality available to users is ever increasing. For example, users are exposed to an every increasing variety of computing devices, such as desktop personal computers (PCs), notebook computers, wireless phones, personal digital assistants (PDAs), game consoles, and so on. Further, the varieties of software that are executable on these devices is ever increasing, from communication applications (e.g., browsers, instant messaging and email), productivity applications (e.g., word processing, spreadsheets, presentations, note taking, graphical design), games, and so on.

One technique that is utilized to help users manage this functionality is through the use of a maintenance service. The maintenance service, for instance, may make recommendations to the users regarding configurations of the computing devices. Because of the variations in functionality available to the users, however, a wide variety of configurations may be employed by the users to gain access to and select from this functionality. For example, the users may choose from the different varieties of computing devices and also choose from the different varieties of software that are available as previously described. Therefore, configurations of software and hardware employed by the computing devices may vary greatly from user to user. Traditional maintenance service techniques, however, did not make distinctions between the computing devices, but rather made general recommendations to be employed by each device. Variations in the configurations, however, may make recommendations inapplicable to one or more of the clients. Further, the recommendations may even result in a decrease in functionality of the “inapplicable” computing devices and resultant frustration on the part of the users.

### SUMMARY

Client category configuration is described. In an implementation, a computer-implemented method is employed to find categories of clients based on configuration data obtained from the clients. A configuration recommendation is then created for a particular one of the categories based on configuration of one or more of the clients included in the particular category.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an illustration of an environment in an exemplary implementation that is operable to employ client category configuration techniques.

FIG. 2 is an illustration of a system in an exemplary implementation showing a client maintenance service and a plurality of clients of FIG. 1 in greater detail.

FIG. 3 is a flow diagram depicting a procedure in an exemplary implementation in which configuration data is used to find categories of clients and create a configuration recommendation for a particular one of the categories.

FIG. 4 is a flow diagram depicting a procedure in an exemplary implementation in which configuration data is processed that contains clients and modules that were not previously detected.

FIG. 5 is a flow diagram depicting a procedure in an exemplary implementation in which an automatic determination is made in relation to a module not previously encountered by a client and recommendations are provided based on whether the module is included in the client's category.

The same reference numbers are utilized in instances in the discussion to reference like structures and components.

### DETAILED DESCRIPTION

Overview

Functionality that is available to users of computing devices is ever increasing. One technique that may be utilized to help users manage this functionality is through the use of a maintenance service. For example, the maintenance service may obtain data from the computing devices regarding configuration of the computing devices, such as decisions made by the users pertaining to applications being executed on the computing devices, files that are selected for backup, and so on. This data may be analyzed for purposes of providing better service back to the users of the service, such as by providing recommendations regarding configuration.

Traditional techniques that were employed by the maintenance services, however, employed a “majority wins” approach to making recommendations. However, these recommendations may not pertain to each computing device, geographical and demographic market, and so on. Accordingly, techniques are described in which collected data may be categorized and recommendations formed based on criteria which match the computing devices in the categories, thereby providing a more meaningful and relevant experience for the users.

For example, the users are more likely to value recommendations that come from their “peers” or people that are similar to them in many ways. A gamer, for instance, might want to know what applications should be allowed access to a network based on decisions made by other gamers, which may even be contrary to decisions made by a “general” customer base. Therefore, these techniques may automatically tailor recommendations to provide a richer experience and improve customer satisfaction.

In the following discussion, an exemplary environment is first described that is operable to perform client category configuration techniques. Exemplary procedures are then described which may be employed in the environment, as well as in other environments.

Exemplary Environment

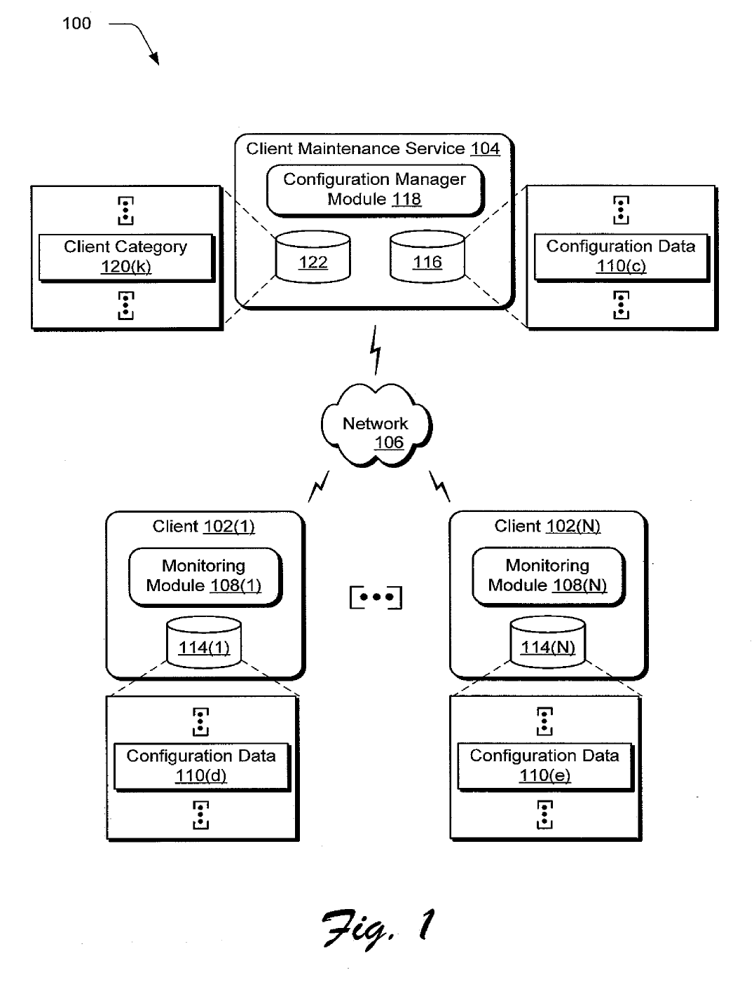

FIG. 1 is an illustration of an environment 100 in an exemplary implementation that is operable to employ client category configuration techniques. The illustrated environment 100 includes a plurality of clients 102(1), . . . , 102(N) that are communicatively coupled to a client maintenance service 104 over a network 106. The clients 102(1)-102(N) may be configured in a variety of ways for accessing the network 106. For example, one or more of the clients 102(1)-102(N) may be configured as a computing device, such as a desktop computer, a mobile station, an entertainment appliance, a set-top box communicatively coupled to a display device, a wireless phone, a game console, and so forth. Thus, the clients 102(1)-102(N) may range from full resource devices with substantial memory and processor resources (e.g., personal computers, game consoles) to low-resource devices with limited memory and/or processing resources (e.g., traditional set-top boxes, hand-held game consoles). The clients 102(1)-102(N) may also relate to a person and/or entity that operate the clients. In other words, one or more of the clients 102(1)-102(N) may describe logical clients that include users, software, and/or devices.

Although the network 106 is illustrated as the Internet, the network may assume a wide variety of configurations. For example, the network 106 may include a wide area network (WAN), a local area network (LAN), a wireless network, a public telephone network, an intranet, and so on. Further, although a single network 106 is shown, the network 106 may be configured to include multiple networks.

The clients 102(1)-102(N) are each illustrated as having a respective monitoring module 108(1)-108(N). The monitoring modules 108(1)-108(N) are representative of logic to monitor configuration of the respective clients 102(1)-102(N). Data generated from this monitoring is illustrated as configuration data 110(d) and data 112(e) (where “d” and “e” can be any integer from one to “D” and “E”, respectively) in respective storage 114(1)-114(N). This configuration data may then be uploaded at period intervals over the network 106 to the client maintenance service 104 and stored in storage 116 as configuration data 110(c).

The client maintenance service 104, as illustrated in FIG. 1, includes a configuration manager module 118 that is representative of functionality to process the configuration data 110(c). For example, the configuration manager module 118, when executed, may examine the configuration data 110(c) to arrive at a plurality of client categories 120(k) (where “k” can be any integer from two to “K”) that are illustrated as being stored in storage 122. The client categories 120(k) reference commonalities of clients within the group. For instance, one such client category 120(k) may be “gamers” which are defined by a particular group of the clients 102(1)-102(N) that permit Internet access to a variety of games. The configuration manager module 118 may then make recommendations to this group as a whole based on actions taken by others in the group.

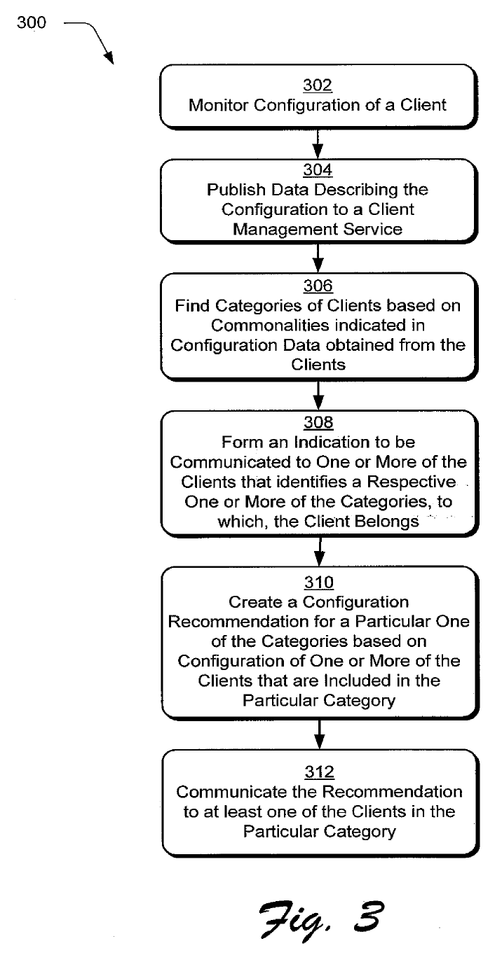

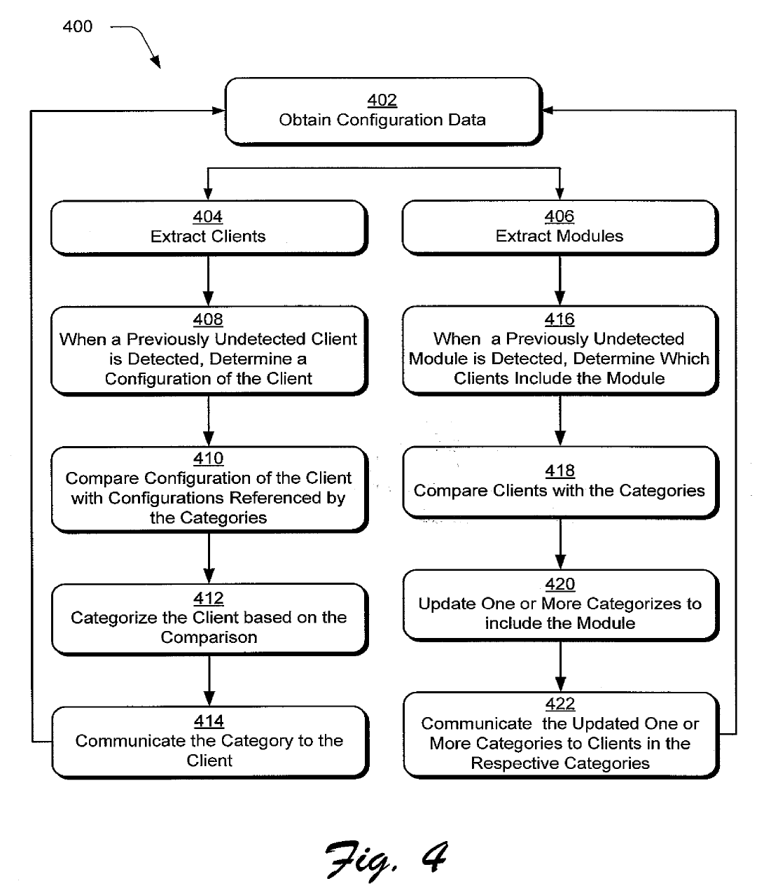

A new game module, for instance, may be provided to the clients 102(1)-102(N) which provides for an “online” experience through access to the network 106. A first few gamers, when setting up the new game module, may permit the game module to access the network 106 through use of a configuration setting. Information regarding this decision may be populated to other clients in that same client category 120(k) (e.g., “gamers”) such that the other clients are not forced to manually set the configuration as was done by those first few gamers. In this way, knowledge absorbed from known client categories may be leveraged to take similar actions on behalf of other clients who have been categorized into the categories. Further discussion of categorization of clients 102(1)-102(N) based on configuration data 110(c) obtained from the clients may be found in relation to FIG. 3. Further discussion of categorization of modules based on configuration data 110(c) obtained from the clients may be found in relation to FIG. 4.

The client maintenance service 104 may also employ the configuration manager module 118 to categorize new clients. For example, a “new” client may join the client maintenance service 104. The configuration manager module 118 may examine the client and based on the examination, place the client into one or more of the client categories 120(k). The client, for instance, may include a variety of games and be placed in a “gamers” category and a variety of accounting software and therefore also be placed in a “finance” category. Recommendations to the client may then be provided based on membership of the client in the respective categories, further discussion of which may be found in relation to FIG. 4.

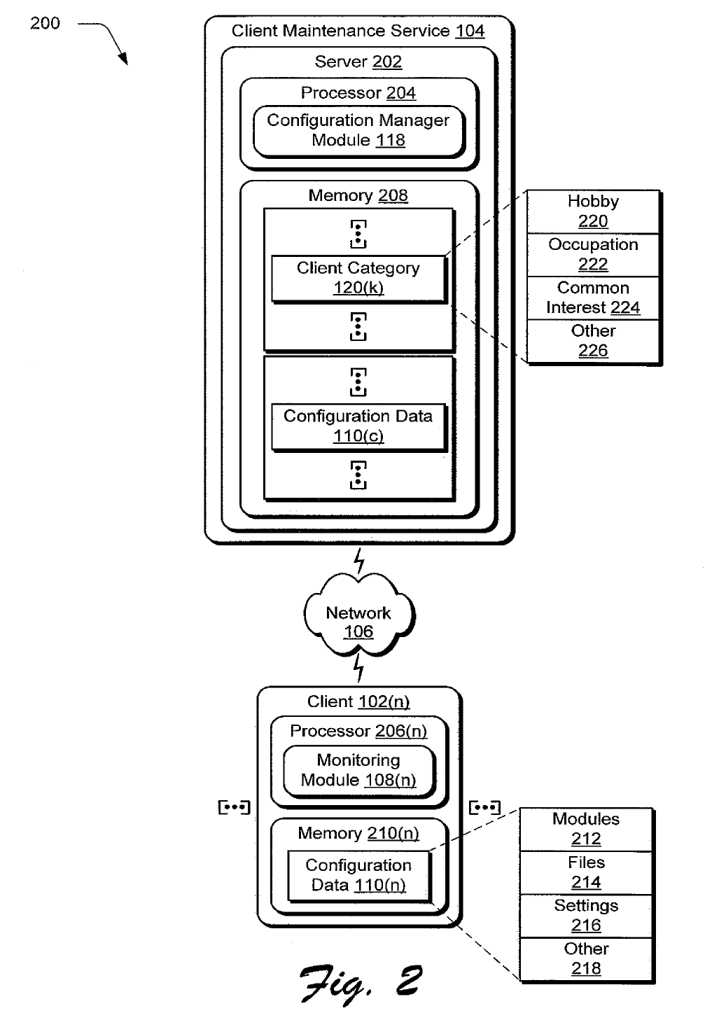

Generally, any of the functions described herein can be implemented using software, firmware (e.g., fixed logic circuitry), manual processing, or a combination of these implementations. The terms “module,” “functionality,” and “logic” as used herein generally represent software, firmware, or a combination of software and firmware. In the case of a software implementation, the module, functionality, or logic represents program code that performs specified tasks when executed on a processor (e.g., CPU or CPUs). The program code can be stored in one or more computer readable memory devices, further description of which may be found in relation to FIG. 2. The features of the client category configuration techniques described below are platform-independent, meaning that the techniques may be implemented on a variety of commercial computing platforms having a variety of processors.

FIG. 2 is an illustration of a system 200 in an exemplary implementation showing the client maintenance service 104 and the plurality of clients of FIG. I in greater detail. The client maintenance service 104 is illustrated as being implemented by a server 202, which although a single server 202 is illustrated, server 202 may be representative of multiple servers, e.g., a server cluster. The client 102(n), which in FIG. 2 is illustrated as a client device, may be representative of any one of the clients 102(1)-102(N). Accordingly, the server 202 and the client 102(n) are illustrated as having respective processor 204, 206(n) and memory 208, 210(n).

Processors are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. Alternatively, the mechanisms of or for processors, and thus of or for a computing device, may include, but are not limited to, quantum computing, optical computing, mechanical computing (e.g., using nanotechnology), and so forth. Additionally, although a single memory 208, 210 is shown, respectively, for the server 202 and the client 102(n), a wide variety of types and combinations of memory may be employed, such as random access memory (RAM), hard disk memory, removable medium memory, and other types of computer-readable media. For example, the client category 120(k) may be maintained in RAM while the configuration data 110(c) may be maintained in a hard disk drive. A variety of other examples are also contemplated.

The client 102(n) is illustrated as executing the monitoring module 108(n) on the processor 206(n), which is also storable in memory 210(n). The monitoring module 108(n), as previously described, is executable to generate configuration data 110(n) that describes the configuration of the client 102(n). For instance, the configuration data 110(n) may described modules 212 (e.g., applications, third-party plug-in modules, and so on), files 214 (e.g., types of files, such as a particular file name extension), settings 216 (e.g., settings of the modules 212, hardware settings and network settings) and “other” 218 configuration data 110(n) that describes the configuration of the client 102(n), such as responses to actions performed during execution of a module, particular behavior in relation to files 214 (e.g., backup storage), and so on.

The configuration data 110(n) of the clients 102(n) may be uploaded to the client maintenance service 104 over the network 106 (such as at periodic intervals, when a threshold amount of data has been generated, and so on) and stored as configuration data 110(c) in memory 208. The configuration data 110(c) may then be processed by the configuration manager module 118 in a variety of ways.

For example, the configuration data 110(c) may be used to generate the plurality of client categories 120(k). For example, the client categories 120(k) may be generated automatically based on similarities detected in configurations of the clients 102(n) through analysis of the configuration data 110(c) by the configuration manager module 118. The similarities of the client categories 120(k) may reflect a wide variety of groupings, such as a hobby 220, occupation 222, a common interest 224 and other 226 commonalities. These commonalities, for instance, may be reflected by the modules 212, files 214, settings 216 included by each of the clients 102(n).

The client categories 120(k) may then be utilized to find configuration recommendations that are particular to that category. Therefore, these recommendations are more likely to be pertinent to each of the clients 102(n) in the category. Additionally, as new clients are encountered, the clients may be categorized into one or more of the client categories 120(k) based on modules 212, files 214 and settings 216 of the new client. Further, new modules (e.g., a new game, productivity application, third-party plugin modules, and so on) may also be categorized based on which clients 102(n) have obtained and/or used the module. Yet further, the client categorization process may be repeated at periodic intervals to realign the client categories 120(k). Further discussion of client category configuration techniques may be found in relation to the following figures.

Exemplary Procedures

The following discussion describes client category configuration techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and the system 200 of FIG. 2.

FIG. 3 depicts a procedure 300 in an exemplary implementation in which configuration data is used to find categories of clients and create a configuration recommendation for a particular one of the categories. Configuration of a client is monitored (block 302). For example, the client 102(n) may execute the monitoring module 108(n) to monitor usage of the client 102(n), such as which applications are included on the client, setting relating to the applications, file types included on the client 102(n), which files are backed up on the client 102(n) (e.g., a finance file configured for storage on two different memory devices), and so on. Additionally, the monitoring may be performed to include a description of performance realized as a result of the change by the clients, such as changes to reliability, performance, and so on after a configuration has changed.

Data describing the configuration is published to a client management service (block 304). The monitoring module 108(n), for instance, may be configured to publish the configuration data 110(n) at periodic intervals, when a configuration has been changed, when a threshold amount of configuration data 110(n) is created, and so on.

Categories of clients are found based on commonalities indicated in the configuration data obtained from the clients (block 306). For example, a category may be formed specifying clients that have a particular combination of modules (e.g., games, finance applications, graphical design applications, third-party plugin modules, and so on), settings for the modules, files (e.g., purchased and downloaded music files), and so on.

An indication is formed to be communicated to one or more of the clients that identifies one or more of the categories, to which, the client belongs (block 308). For example, the indication may describe that the client is a member of the “gamers” category and a “finance” category. This indication may or may not be exposed to a user. For example, the indication may be communicated for use by the monitoring module 108(n) without notifying a user as to the categories. In another example, the indication is output for viewing by a user such that the user may accept, decline or change one or more of the categories. A variety of other examples are also contemplated.

A configuration recommendation is created for a particular one of the categories based on configuration of one or more of the clients that are included in the particular category (block 310). For example, a subset of clients in the finance category may enable a financial application to access financial accounts over a network every half hour. This access, however, may cause a significant decrease in the performance of the client. On the other hand, another subset of the clients in the finance category may permit access by the financial application to financial accounts every hour and experience a minor reduction in functionality. Therefore, a recommendation may be formed which indicates that the network access setting for the financial application should be set to access every hour.

In another example, the configuration manager module 118 may determine that clients in the finance category typically backup files with a particular extension. Therefore, a recommendation may be formed for the finance category that suggests backup of files having that extension. A variety of other examples are also contemplated.

The recommendation is communicated to at least one of the clients in the particular category (block 312). For instance, recommendations for each of the groups may be packaged and communicated to each one of the plurality of clients 102(1)-102(N). The clients, through use of the indication of categories, to which, the respective clients belong, may then determine which of the recommendations are pertinent to the client.

In another instance in which the client makes the determination of the categories, to which, the clients belong, this packaging may serve to protect the privacy of the client regarding category membership by having the client 102(n) determine which recommendations are pertinent. A variety of other instances are also contemplated.

FIG. 4 depicts a procedure 400 in an exemplary implementation in which configuration data is processed that contains clients and modules that were not previously detected. Configuration data is obtained (block 402), such as configuration data published from the plurality of clients 102(1)1-2(N), configuration data obtained from a data extraction service, and so on.

Clients (block 404) and modules (block 406) are extracted from the configuration data, such as through the use of globally unique identifiers (GUIDs), hashes of represented data (e.g., a hash value generated from data of a particular file), and so on. A variety of other extraction techniques are also contemplated.

When a previously undetected client is detected, a configuration of the client is determined (block 408). For example, the configuration manager module 118 may determine which modules are included on the client, settings for the modules, file types, which files were backed up by the client, and so on.

The client is categorized based on the comparison (block 412), such as by comparing configurations specified by the categories with the configuration of the client. It should be noted that in an implementation, the client is permitted membership to multiple categories. In this implementation, conflicting recommendations may be resolved by prioritizing the categories, such as by determining that the client is more suited to membership in one particular category over another category and therefore recommendations for the particular category “win”. In another implementation, membership is restricted to one category and therefore conflicting recommendations are not encountered.

The category is communicated to the client (block 414). Therefore, in this example the processing is performed by the client maintenance service 104 through execution of the configuration manager module 118. In another example, the client 102(n) may perform all or part of the processing, such as by determining by a client 102(n) which of a plurality of categories defined by the client maintenance service 104 correspond to the client 102(n). A variety of other examples are also contemplated.

Similar techniques may be employed to find one or more categories for a previously undetected module. For example, when a previously undetected module is detected, a determination is made as to which clients include the module (block 416). The clients that include the module are then compared with the categories (block 418). One or more of the categories may then be updated to include the module (block 420). For example, it may be determined that a significant percentage of the clients that include the module are also members of a “gamers” category. Therefore, a definition of the “gamers” category may be updated to include the module. The updated one or more categories may then be communicated to the clients in the respective categories (block 422). Therefore, in this instance, the client is able to determine category membership based on the definitions of the categories. A wide variety of other examples are also contemplated as previously described.

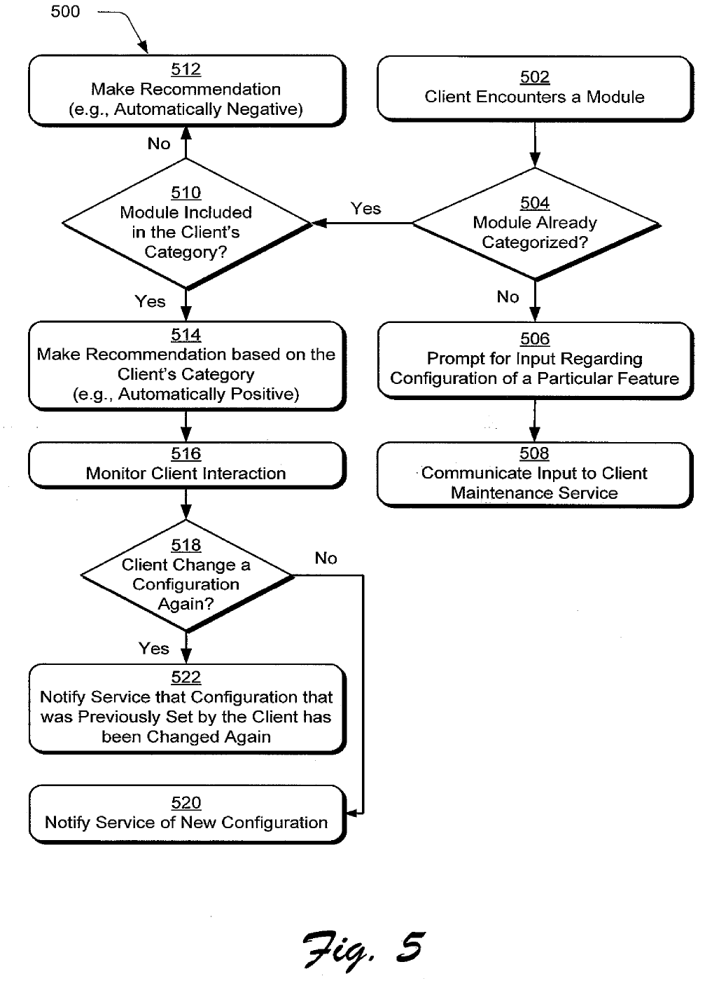

FIG. 5 depicts a procedure 500 in an exemplary implementation in which automatic determination is made in relation to a module not previously encountered by a client and recommendations are provided based on whether the module is included in the client's category. A client encounters a module (block 502). For example, the client 102(n) may download a module via the network 106 from a content provider.

A determination is made as to whether the module is already categorized (decision block 504). For example, the monitoring module 108(n) may include a listing of previously identified modules obtained from the client maintenance service 104 and consult this list whenever a new module is encountered by the client 102(n).

When the module has not been categorized (“no” from decision block 504), the client 102(n) prompts for input regarding configuration of a particular feature (block 506). The prompt, for instance, may be whether to permit the module to access the network 106. The client 102(n) may then receive the input in response to the prompt on whether to permit access. This input may also be communicated to the client maintenance service (block 508). In this way, the client maintenance service 104 may collect inputs regarding configuration of the module and make recommendations to other clients based on the collected inputs.

When the module has been categorized (“yes” from decision block 504), a determination is made as to whether the module is included in the client's category (decision block 510). When the module is not included (“no” from decision block 510), an appropriate recommendation is made (block 512). For example, the monitoring module 108(n) may automatically give a negative recommendation (e.g., a warning) to caution a user when the module lies “outside” the client's category.

When the module is included (“yes” from decision block 510), a recommendation is made based on the client's category (block 514). Continuing with the previous example, a “positive” recommendation may be made to permit network access based on inclusion of the module within the client's category. A variety of other examples are also contemplated.

Changes in previously set configurations may also be monitored and given special consideration. For example, by monitoring client interaction (block 516) a change in a configuration may be detected. A determination is then made as to whether the client has changed this configuration again (decision block 518). If not (“no” from decision block 518), the service (e.g., the client maintenance service) is notified of the new configuration (block 520). If so (“yes” from decision block 518), however, the service is notified that configuration that was previously set by the client has been changed again (block 522). In this way, the monitoring module 108(n) “flags” the configuration data 110(n) such that the client maintenance service 104 may give special consideration to the configuration data. It should be noted that in another example, the configuration maintenance service 104, itself, may perform the processing to determine when the configuration was changed. Therefore, because a change to a previous setting may indicate a previous undesirable result, that change may be given special consideration when making future recommendations. A variety of other examples are also contemplated.

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A computer-implemented method comprising:
finding categories of clients based on configuration data obtained from the clients; and
creating a configuration recommendation for a particular one of the categories based on configuration of one or more of the clients included in the particular category.

2. A computer-implemented method as described in claim 1, wherein the categories are defined by criteria that include which applications, files, settings and plug-in modules are included by clients in the respective categories.

3. A computer-implemented method as described in claim 1, wherein the categories correspond to hobbies or occupations of respective said clients.

4. A computer-implemented method as described in claim 1, wherein the configuration data describes actions taken by modules executed on respective said clients and reactions to the actions taken by the respective said clients.

5. A computer-implemented method as described in claim 1, wherein:
the configuration data describes particular types of data that were backed-up by respective said clients; and
the configuration recommendation identifies at least one of the particular types.

6. A computer-implemented method as described in claim 5, wherein the particular types are identified via file extensions.

7. A computer-implemented method as described in claim 1, wherein:
the configuration data describes network access that was permitted to modules included on respective said clients; and
the configuration recommendation identifies permissible or impermissible network access regarding the modules to clients included in the particular category.

8. A computer-implemented method as described in claim 1, further comprising:
communicating the configuration recommendation to at least one of the clients included in the particular category; and
determining by the at least one of the clients whether the configuration recommendation is applicable to the clients.

9. A computer-implemented method as described in claim 1, further comprising categorizing a new client by comparing configuration of one or more modules on the new client with configurations described in each of a plurality of categories.

10. A computer-implemented method as described in claim 1, further comprising:
when a previously undetected module is detected in subsequent configuration data obtained from the clients, determining which of the clients include the module;
ascertaining which categories correspond to the clients that include the previously undetected module; and
updating at least one of the ascertained categories to include the previously undetected module

11. A computer-implemented method comprising:
categorizing a client by comparing configuration of one or more modules on the client with configurations described in each of a plurality of categories; and
communicating a recommendation regarding configuration of at least one said module to the client based on the categorizing.

12. A computer-implemented method as described in claim 11, wherein the categories are defined by criteria that include which applications, files, settings and plug-in modules are included by clients in the respective categories.

13. A computer-implemented method as described in claim 11, wherein the categories correspond to hobbies or occupations of respective said clients.

14. A computer-implemented method as described in claim 11, wherein the categories correspond to actions taken by modules executed on respective said clients and reactions to the actions taken by the respective said clients.

15. A computer-implemented method as described in claim 11, further comprising:
communicating an identification of the category to the client; and
determining, by the client, whether a subsequent recommendation regarding configuration is pertinent to the client based on the identification of the category.

16. A method as described in claim 11, farther comprising:
determining which of the clients include a previously undetected module;
ascertaining which categories correspond to the clients that include the previously undetected module; and
updating at least one of the ascertained categories to include the previously undetected module.

17. A computer-implemented method comprising:
when a previously undetected module is detected in configuration data obtained from a plurality of clients, determining which of the clients include the module;
ascertaining which categories correspond to the clients that include the module, wherein each of the categories describes a configuration of one or more other modules; and
updating at least one of the ascertained categories to include the module.

18. A computer-implemented method as described in claim 17, wherein each of the categories was found based on previous configuration data obtained from one or more of the clients.

19. A computer-implemented method as described in claim 17, wherein the categories are defined by criteria that include which applications, files, settings and plug-in modules are included by clients in the respective categories.

20. A computer-implemented method as described in claim 17, further comprising:
communication at least one of the updated categories to the plurality of clients;
creating configuration recommendations based on the categories; and
communicating the configuration recommendations to the plurality of clients, such that, east said client is to determine whether each said configuration recommendation is pertinent to the client based on the updated categories.
